(19) United States
(12) Patent Application Publication
(10) Pub. No.: US 2004/0210516 A1
(43) Pub. Date: Oct. 21, 2004

(54) Device, system and method for automated account data access

(76) Inventor: Jon Goldman, Riverside, CA (US)

Correspondence Address: Karl M. Steins, Steins & Associates, Suite 120, 2333 Camino del Rio South, San Diego, CA, 92108, US

(21) Appl. No.: 10/418,005

(22) Filed: Apr. 16, 2003

(51) Int. Cl. G06F 17/60

(52) U.S. Cl. 705/39

(57) ABSTRACT

A Device, System and Method for Automated Account Data Access is disclosed. Once setup is complete, the system enables the user to simply scan a credit, debit, smart or other card, after which the user's specific account history for that card will be presented on a display screen for review. The card scanning device is connectable to a computing device via wired or wireless means. Versions of the system may further be available that include a personal computer and a kiosk-type system for public use.

### BACKGROUND OF THE INVENTION

1. Field of the Invention

This invention relates generally to Financial Transaction Systems and, more specifically, to a Device, System and Method for Automated Account Data Access.

2. Description of Related Art

Credit, debit, ATM and smart cards are exploding in popularity. It is nearly unheard of for a person not to have at least one of these cards, and in many cases, a particular user may carry several different cards. This phenomena will continue to evolve as the financial institution infrastructure continues to promote their use in order to obtain the cost savings and security that they provide over standard paper checks.

While the convenience of the cards is well-known, there is one significant drawback to their use—unlike the paper check system, there is no transaction register in the user's possession as he or she is carrying the card. As a result, it can be a constant question whether or not there is adequate finds or credit to make a purchase transaction; the user must now attempt to make payment, and will only be either approved or denied—there is no balance-checking capability. What would be beneficial would be a system and method that enabled a user to easily check his or her credit of funds balance at a particular financial institution.

Clark, U.S. Pat. No. 5,815,577 for “Methods and Apparatus for Securely Encrypting Data in Conjunction with a Personal Computer” provides a version of a solution to the aforementioned problem. The deficiency of the Clark apparatus is that since it provides full account access to the user, including funds transfer and other actual monetary transactions, it is required to have very substantial security protections to prevent unauthorized use. The encryption and other measures used by Clark actually defeat the functionality of the apparatus because it is not feasible for distribution to numerous private and public locations so that users can easily obtain only their balance information.

While conventional ATM's do provide balance information, they are limited when they are not a member of the network of ATM's subscribed to by the card-issuer's financial institution—therefore transactions can be conducted, but a simple balance request cannot be made when the user is using an ATM that is outside “their network.” Furthermore, the ATM functionality is not available for use at a home computer, again, because the ATM offers much more functionality than is necessary to obtain a simple account balance.

### SUMMARY OF THE INVENTION

In light of the aforementioned problems associated with the prior systems and methods, it is an object of the present invention to provide a Device, System and Method for Automated Account Data Access. Once setup is complete, the system should enable the user to simply scan a credit, debit, smart or other card, after which the user's specific account history for that card will be presented on a display screen for review. The card scanning device should be connectable to a computing device via wired or wireless means. Versions of the system should be available that include a personal computer and a kiosk-type system for public use.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIGS. 1 and 1A depict the process for setting up and initiating a card for use with the device and system of the present invention;

FIG. 2 depicts the process for use of the device and system of the present invention;

FIG. 3 depicts a preferred embodiment of the device of the present invention as it is physically integrated with Financial Institutions;

FIG. 4 depicts the simple sequence experienced by the user in operating the device and system of the present invention;

FIG. 5 depicts an alternate embodiment of the pertinent elements of the present invention; and

FIG. 6 depicts yet another alternate embodiment of the device of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Device, System and Method for Automated Account Data Access.

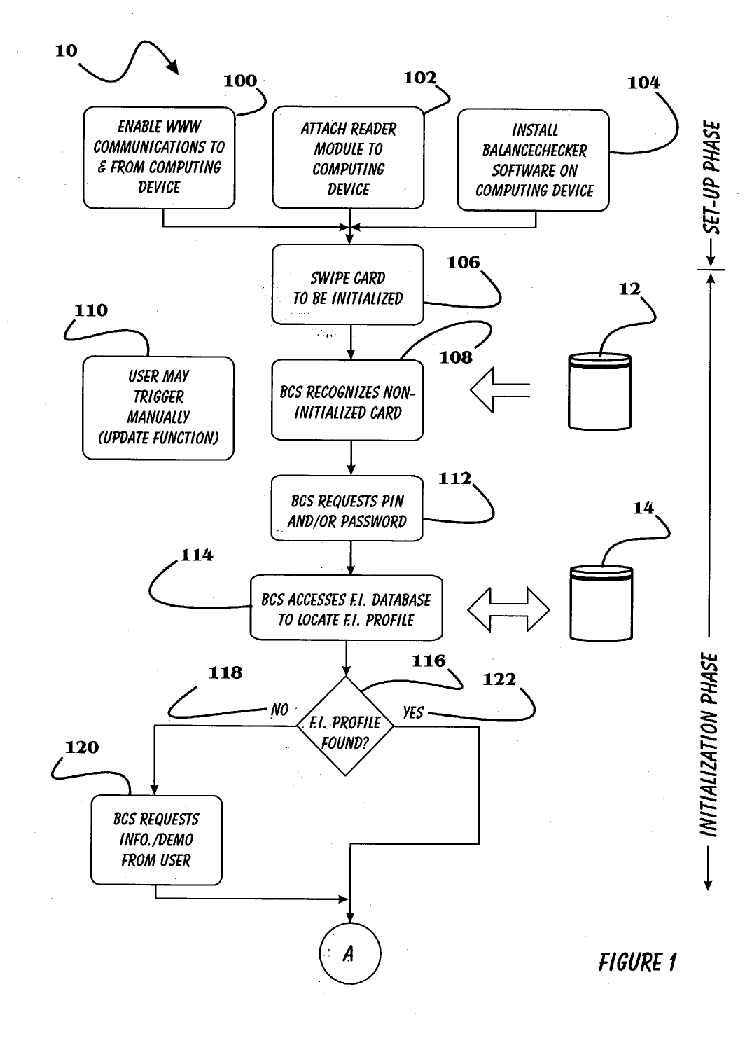

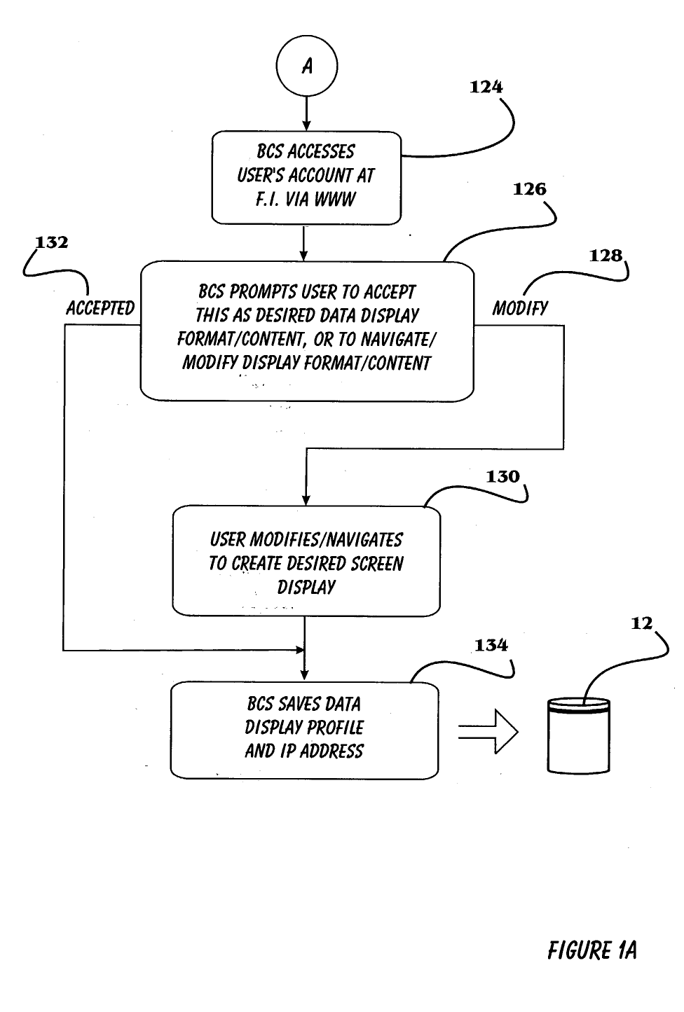

The present invention can best be understood by initial consideration of FIG. 1 (and 1A). FIGS. 1 and 1A depict the process 10 for setting up and initiating a card for use with the device and system of the present invention. Although not stated, it should be mentioned that the user must start with an unmodified computing device similar to a personal computer, a reader module as will be discussed further below in connection with other drawing figures, and the computer software that will be run on the computing device in order to execute the processes described herein. That having been stated, in no particular order, the user must establish and/or enable communications between the computing device and the World Wide Web 100. This communication capability can be provided in a variety of conventional forms, including modem, DSL, cable, wireless, or even cellular.

The reader module must be further interconnected or otherwise be configured such that it can communicate with the computing device 102. In some versions, the computing device might actually have the reader module built right into it as an integrated element.

A final step is to install the “balancechecker” software onto the computing device in such a way that it is compatible for selectively running the BCS on the computing device 104.

Now that the set-up phase is complete, the Balance Checker System (“BCS”) is ready for operation. First, the user must swipe a magnetic card that is desired to be initialized 106. The card may be a credit card, a debit card, an atm card or other similar financial transaction card; a magnetic card swiping is used here as only one example of the embodiments conceived.

The BCS interprets the card swipe as a command to query a user account data repository 12 to see whether or not the card is known by the system, and whether it is set up adequately. The repository 12 is a conventional data file residing on a conventional electronic storage medium, such as one of a variety of “drives.” The BCS will access the repository 12 using the account (and other) data read from the card when it was swiped.

Since this is the first swipe of this particular card, the BCS will fail to find it in the repository 12, which is interpreted by the BCS as a request for initialization of the card 108. Should the user wish, he or she can activate the “initialization” of a card 110 in order to conduct a manual update to the data stored in the user account data repository 12.

Upon recognizing an uninitialized card, the BCS will request that the user enter a password and/or a PIN (personal identification number). The password is a BCS-utilized, card- or user-specific code that grants the user access to BCS functionality. The password will need to be entered whenever the user wishes to access financial information for future BCS uses. The PIN is a code assigned by the financial institution that granted the user the card. The PIN will only need to be entered at this initialization stage, and not necessarily for future uses of the BCS unless the user is making an access request from another computing device (and therefore a different BCS).

Once the password and/or PIN have been entered, the BCS will access the BCS financial institution profile repository 14 in order to attempt to locate a profile for the financial institution. If found, a financial institution profile will contain the world wide web address of the financial institution that issued the card, the particular format or parsing information such that the desired data can be identified and displayed by the BCS for the user. Furthermore, the profile will identify what the site logon steps are that will permit the BCS to access the user's account data. As with the user account data repository 12, the financial institution profile repository 14 is a data file maintained within the BCS on (or otherwise accessible to, for example over the world wide web) the computing device.

If the financial institution's profile is not found in the repository 118, the BCS will inform the user of this fact, and will request that the user provide the critical profile information from the user. This request may be optionally answered by the user by demonstration. Somewhat like the automatic recording of a macro program, the BCS will observe and record while the user (through the BCS operating portal) locates the financial institution over the world wide web and then displays the account information as desired.

Once the financial institution profile has been created or obtained from the repository 14, step A takes us to FIG. 1A, where the next step involves the BCS accessing the user's account at the financial institution via the world wide web 124.

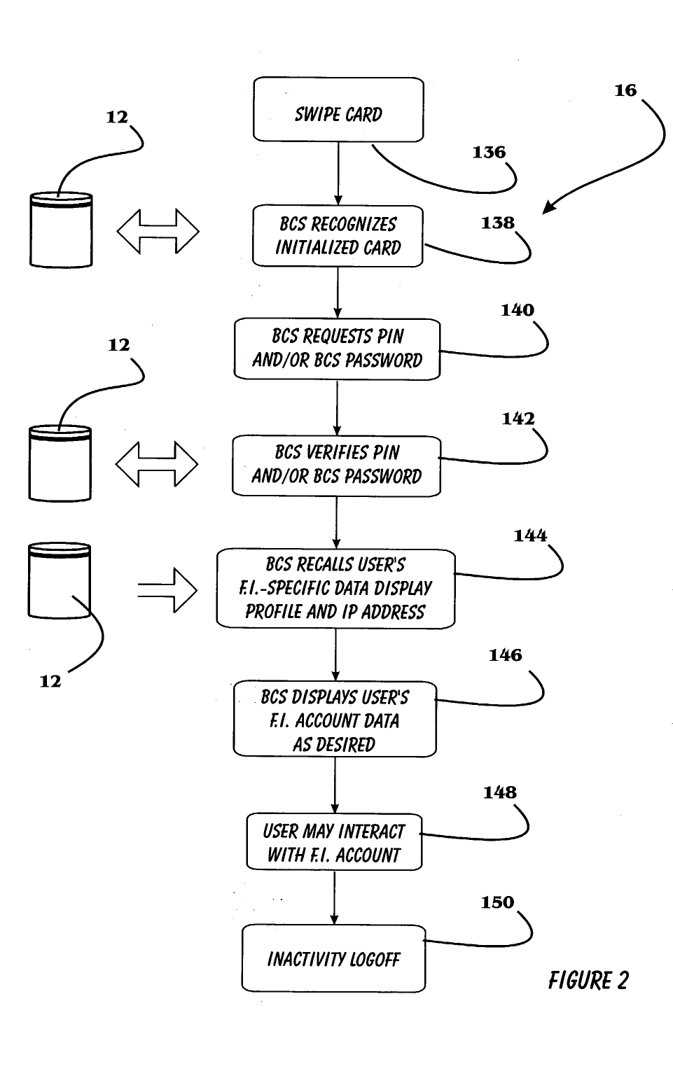

Once connected to the F.I. web site, the BCS prompts the user to accept the displayed screen or page as the data desired by the user for future access sessions 126. The BCS will further give the user the opportunity to modify 128 or, alternatively navigate through the F.I. website until the desired page and data is displayed 130. The navigation will be recorded by the BCS in the same ways that the financial institution profile can be recorded (as discussed above). Once the desired data display is accepted 132, the BCS stores the data display profile and world wide web address of the particular view in the user account data repository 12, such that this exact display will appear every time the user utilizes the BCS to access his or her account. Now turning to FIG. 2, we can examine the operation of the BCS once a card has been initialized.

FIG. 2 depicts the process for use of the device and system of the present invention 16. The process 16 commences by swiping a card (that has been initialized with the BCS) 136. By accessing the user account data repository 12, the BCS will quickly determine that the card is recognized (i.e. it has been initialized) 138. Next, the BCS will request that the user enter his or her BCS password into the computing device (see FIG. 1) 140. The BCS will verify the BCS password 142 by again accessing the user account data repository 12. Immediately, the BCS will recall the user's financial-institution-specific data display, and therefore the world wide web address of the desired data display 144 from the user account data repository 12.

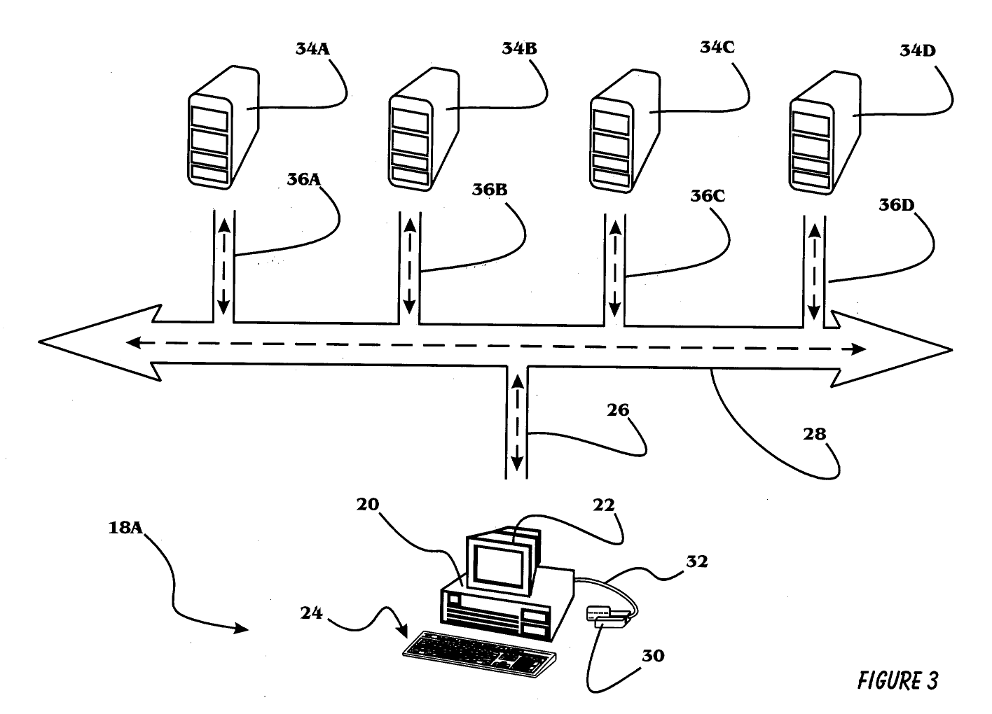

The BCS will next display the user's desired account data for the swiped card 146, and will permit the user to interact with their account information and/or operate additional functionality at the financial institution's website 148. For security purposes, the user will be logged out 150 of the financial institution's website either in response to manual request by the user or by failing to interact with the site (or the BCS) for a pre-determined (and user-changeable) period of time. A review of FIG. 3 will provide illumination as to the physical elements of the BCS system.

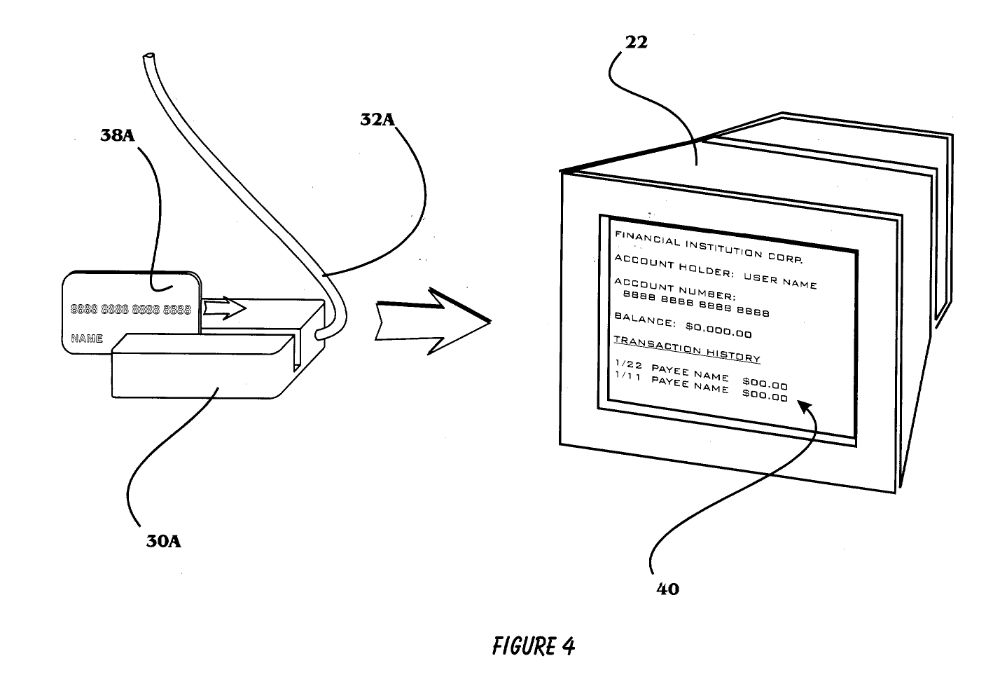

FIG. 3 depicts a preferred embodiment of the device of the present invention 18A as it is physically integrated with Financial Institutions. All components in the operation connect to the world wide web conduit 28 (which is simply a way to identify the network in a tangible way). The automated account access device 18A comprises a computing device 20, such as the personal computer depicted, a display device 22, such as the cathode ray tube shown. The device 18A further may include a keyboard 24 and, a card reader 30 in communication with the device 18A via communication means 32, for example the cable shown. The device 18A is connectable to the world wide web conduit 28 via a port 26. A world wide web port 26 may be a modem connected through a telephone line, through a Digital Subscriber Line, through a cable or even through a wireless connection. Each of the particular financial institution web sites or computer servers 34 must be accessible through the world wide web 28. While each financial institution is depicted here as having a separate server computer 34 and port 36, it should be understood that this is simply to provide clarity; in some cases, financial institutions may share server computers 34, particularly where the institutions are owned by the same corporation. Now turning to FIG. 4 we can see in a single sheet how easy the system is to interact with.

FIG. 4 depicts the simple sequence experienced by the user in operating the device and system of the present invention. As shown, the user first swipes a (initialized) magnetic stripe card issued by a financial institution 38A through a magnetic card reader 30A that is connected to a computing device (not shown) by communication means 32A, namely the cable shown. After the user enters a password at the computing device (e.g. at a keyboard), the user-configured financial institution account data display 40 is provided on the display device 22. Unlike that prior systems, there is no need for additional encryption at the reader 30A or computing device (not shown) nor a dedicated interconnection with the financial institution's server computer. This simplicity provides extremely quick and easy access to the user's account information; since no manipulation of the financial data is permitted, it is unnecessary for these additional security steps—the verification of the physical card 38A is sufficient to provide account data display access.

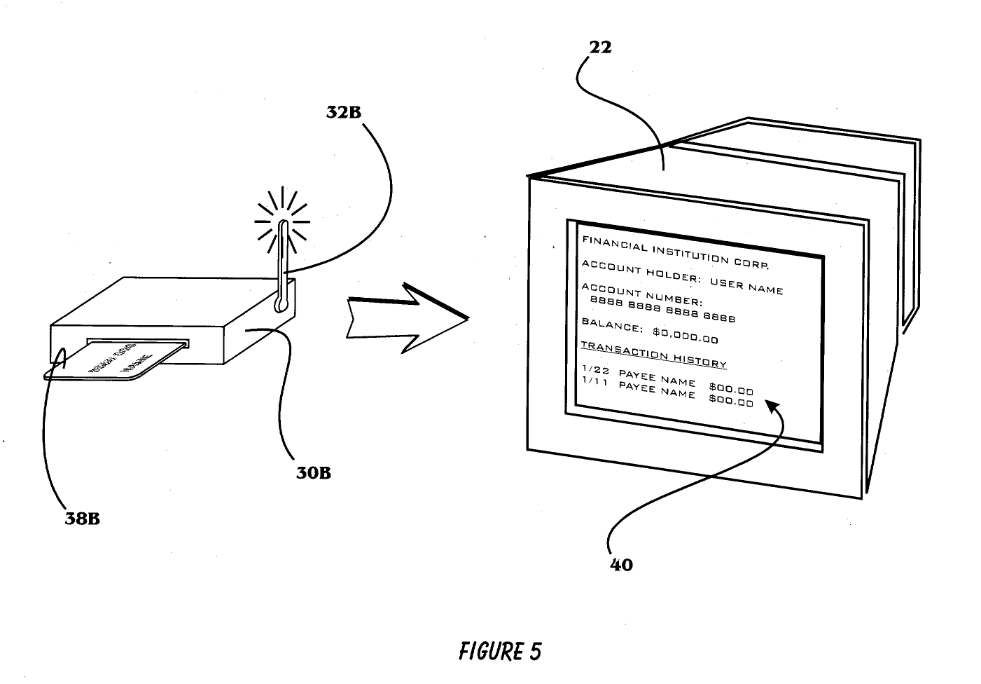

Similarly, FIG. 5 depicts an alternate embodiment of the pertinent elements of the present invention. In this version, the BCS card reader is one configured to accept “smart cards.” As is well-known, a smart card is a device that is a hybrid between a magnetic-stripe card (e.g. credit, debit and ATM cards) and a computing device. A smart card not only has the ability to store information passively (like the magnetic stripe cards), but also has the capability of performing some level of computation and response to information queries—these are active activities.

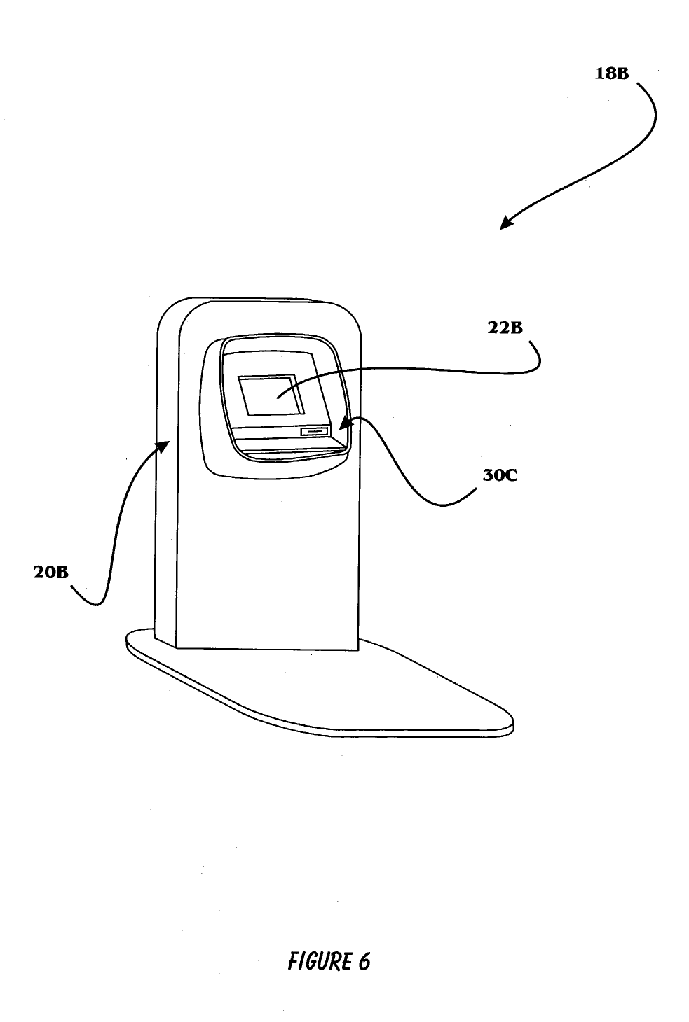

In the embodiment of FIG. 5, the reader 30B is used to read the pertinent information from a smart card 38B inserted therein. The reader 30B includes communication means 32B that, in this case, is via a wireless communications connection with the computing device. As with the embodiment of FIG. 4, the immediate result of the smart card 38B being read is the display of the user-configured financial institution account data history 40 on the display device 22. Finally, turning to FIG. 6, we can examine yet another embodiment of the device of the present invention.

FIG. 6 is a perspective view of a kiosk-type automated account access device 18B. It is believed that the system of the present invention is readily distributable to publically-available kiosks 18B so that a user might be able to access his or her account data while away from their personal computing device. The kiosk-type devices 18B would be in communication with a centralized user account data repository and BCS financial institution profile repository, and as such, would permit the user to initialize their card(s) once for the entire network of kiosks 18B, after which the automated account data display of the BCS would be enabled from any and all kiosks 18B.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A system for displaying data, consisting essentially of:
a wide area computer network communication conduit;
a plurality of financial institution server computing devices comprising wide area network communication conduit communication means, said server computing devices configured to transmit user-specific account data responsive to said specific user's request;
a computing device comprising at least one storage device, at least one processing device, a visual display device for displaying information, and wide area network communication means for communicating with said financial institution server computing devices;
a card reader for reading digital information from a card; and
a balancechecker routine for execution on said computing device for accepting digital information read from a said card and responsively displaying user-specific account data on said visual display device.

2. The system of claim 1, further comprising a user account data repository, said user account data repository comprising a digital data file means resident on said storage device and accessible to said balancechecker routine, said user account data repository including user-specific financial institution server computer data addressable over said wide area computer network conduit.

3. The system of claim 2, further comprising a financial institution profile repository, said financial institution profile repository comprising a digital data file means resident on said storage device and accessible to said balancechecker routine, said user account data repository including financial institution server computer data addresses, said addresses addressable over said wide area computer network conduit.

4. A method for initializing an automated account data display system, comprising the steps of:
installing a balancechecker routine on a computing device;
attaching a reader module to said computing device;
enabling wide area network communication to and from said computing device;
reading digital data from a card, said reading conducted by said reader module;
determining that said read card is non-initialized, said determining conducted by said balancechecker routine being executed on said computing device;
requesting that a user enter a password;
obtaining a user-entered password, said user entering conducted via an input device associated with said computing device;
locating financial institution profile data, said locating conducted by said computing device; and
obtaining a display of a user's account information from a financial institution server computer in communication with said computing device.

5. The method of claim 4, wherein said display obtaining comprises the steps of:
transmitting unencrypted data read from said card to said financial institution server computer via said wide area network;
obtaining said user's user-specific account data from said financial institution server computer; and
displaying said user-specific account data on a display device in operative communication with said computing device.

6. The method of claim 5, further comprising the steps of:
requesting a user to accept said display of said user's account information from a financial institution; and
permitting said user to modify said display responsive to said request.

7. The method of claim 6, wherein said permitting step comprises recording user inputs transmitted to said financial institution server computer automatically as said user transmits said inputs.

8. The method of claim 7, further comprising a step of storing a wide area network address representative of said user-approved data display from said financial institution server computer.

9. A method for automatically obtaining a user-specific display of data from a financial institution server computer in communication with a wide area network conduit, the method comprising the steps of:
reading digital data from a card, said reading conducted by said reader module;
determining that said read card is initialized, said determining conducted by a balancechecker routine being executed on a computing device;
requesting that a user enter a password;
locating financial institution profile data, said locating conducted by said computing device; and
obtaining a display of a user's account information from a financial institution server computer in communication with said computing device.

10. The method of claim 9, wherein said display obtaining comprises the steps of:
transmitting unencrypted data read from said card to said financial institution server computer via said wide area network;
obtaining said user's user-specific account data from said financial institution server computer; and
displaying said user-specific account data on a display device in operative communication with said computing device.
